(19) United States
(12) Patent Application Publication
(10) Pub. No.: US 2010/0208289 A1
(43) Pub. Date: Aug. 19, 2010

(54) BAGGAGE TAGGING SYSTEM AND METHOD FOR GENERATING AN ADDITIONAL BAGGAGE ROUTING TAG

(76) Inventor: Craig C. Mateer, Orlando, FL (US)

Correspondence Address: FOLEY & LARDNER LLP, 150 EAST GILMAN STREET, P.O. BOX 1497, MADISON, WI, 53701-1497, US

(21) Appl. No.: 12/555,905

(22) Filed: Sep. 9, 2009

Related U.S. Application Data
(63) Continuation-in-part of application No. 12/371,288, filed on Feb. 13, 2009.

(51) Int. Cl. G06F 3/12; G06Q 10/00; G06Q 50/00

(52) U.S. Cl. 358/1.15; 705/5

(57) ABSTRACT

A baggage tagging system in which information about additional baggage routing is communicated to an airline computer or server, and an additional routing tag including the additional baggage routing data is generated and is attached to a traveler's bags. An initial tag used for air travel is printed at a remote location and attached to the traveler's bags. By utilizing the initial and additional routing tags, the traveler's bags are efficiently routed from the pick-up location to a selected destination.

### CROSS REFERENCE TO RELATED APPLICATIONS

This application is a continuation-in-part of U.S. patent application Ser. No. 12/371,288, filed Feb. 13, 2009, and entitled “BAGGAGE TAGGING SYSTEM AND METHOD HAVING DATA FROM MULTIPLE SOURCES,” which is herein incorporated by reference.

### FIELD

The subject of the disclosure relates generally to baggage management systems. More specifically, the disclosure relates to a baggage tagging system and method having data from multiple sources.

### BACKGROUND

U.S. Patent Application Publication No. 2006/0145852 assigned to ARINC Incorporated of Annapolis, Md., describes a “system and method for checking in ship-board passengers and their baggage for an airline flight [that] includes issuing a valet receipt for the passenger prior to baggage check-in, to be replaced by the airline bag tag when the passenger is ready to hand over bags to baggage handling personnel.”

In the situation where a passenger of an airline flight is also traveling on a ship, such as a cruise boat, the ARINC baggage system described in U.S. Patent Application Publication No. 2006/0145852 discloses a self-service kiosk from which a passenger may obtain a valet receipt and/or tag indicating that the passenger has enrolled in the service. A cruise ship server transmits the bag tag information to a baggage service system, which prints an International Air Transport Association (IATA) bag tag. The valet tags are later replaced with the IATA bag tag by baggage handling personnel. The baggage system then send a message to an airline system manager that the bags have been processed. U.S. Patent Application Publication No. 2006/0145852 discloses that the bag tag printing is done only on the ship, both on the ship and dockside, or only dockside. However, for a variety of different reasons, including reducing human error, accuracy in shipping, and expediting processing of passenger baggage, it would be advantageous to have information associated with both a second mode of transportation or lodging (such as a cruise ship, a train, a hotel, a resort, etc.) be communicated to an airline computer or system and entered into a traveler's record, wherein this information is included on an additional routing baggage tag that is attached to the traveler's bags.

### SUMMARY

A representative embodiment relates to providing a baggage tagging system in which information about additional baggage routing is communicated to an airline computer or server. An additional routing baggage tag including the additional baggage routing data is generated and is attached to a traveler's one or more bags. An initial baggage tag used for air travel is generated at a remote location and attached to the traveler's bags. By utilizing the initial and additional routing baggage tags, the traveler's bags are efficiently routed from the pick-up location to a selected destination.

In a first representative embodiment, a method includes receiving first travel information that includes information on air travel and receiving additional baggage routing data for a subsequent mode of transportation or lodging. The method further includes communicating a check-in request to an airline computer to register a traveler and the one or more bags of the traveler with an airline, and communicating the additional baggage routing data to the airline computer. A record of the traveler on the airline computer is updated with the additional routing baggage data, and the additional routing baggage data is included on an additional routing baggage tag applied to the one or more bags of the traveler at an airport or other facility associated with the airline.

In a second representative embodiment, a system includes a baggage management computer that receives first travel information that includes air travel information, receives an airline bag tag identifier from an airline computer, and receives additional baggage routing data for a traveler's bags from a second transportation mode computer. The baggage management computer also communicates a check-in request to the airline computer to register the traveler and the one or more bags with an airline, and communicates the additional baggage routing data to the airline computer. A record of the traveler on the airline computer is updated with the additional routing baggage data, and the additional routing baggage data is included on an additional routing baggage tag applied to the traveler's one or more bags at an airport or other facility associated with the airline. The system further includes a printing device that receives the airline bag tag identifier from the baggage management computer and prints an initial bag tag that includes the airline bag tag identifier.

Other principal features and advantages will become apparent to those skilled in the art upon review of the following drawings, the detailed description, and the appended claims.

### BRIEF DESCRIPTION OF THE DRAWINGS

Representative embodiments are hereafter described with reference to the accompanying drawings.

FIG. 1 is a block diagram depicting a system in which a baggage management server operates to provide baggage identification for at least two transportation modes in accordance with a representative embodiment.

FIG. 2 is a flow diagram of representative operations performed in the system of FIG. 1.

FIG. 3 is block diagram depicting a baggage tag management system in accordance with a representative embodiment.

FIG. 4 is a general diagram illustrating a user interface in accordance with a representative embodiment.

FIG. 5 is a general representation of an initial baggage tag and an additional routing baggage tag in accordance with a representative embodiment.

### DETAILED DESCRIPTION

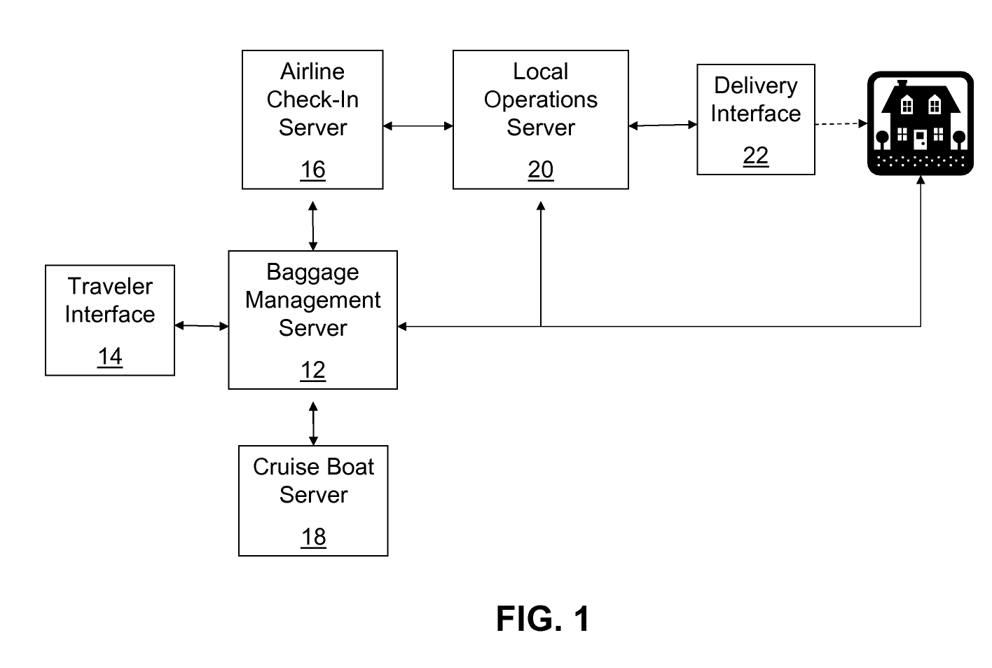

FIG. 1 illustrates a system in which a baggage management server operates to provide additional baggage identification beyond a first transportation mode. In the system, a traveler or someone designated by the traveler (e.g., a travel agent) communicates with a baggage management server 12 via a user interface such as a traveler interface 14. Traveler interface 14 can include an Internet web page running on a personal computer (PC) or a personal data assistant (PDA), an interface on a communication device such as a telephone, or an electronic data input device. Baggage management server 12 is communicatively coupled to an airline check-in server 16 such that data necessary to check a traveler in for an airline flight can be communicated. Airline check-in server 16 provides flight information including a flight number and an IATA (International Air Transport Association) bag number for baggage tags that are attached to baggage to be “checked,” meaning baggage carried during travel by the airline separately from the passenger cabin.

Baggage management server 12 is also communicatively connected to a cruise boat server 18 such that data regarding a cruise including—for example—a departure day and/or a departure time can be communicated from cruise boat server 18 to baggage management server 12. In alternative embodiments, baggage management server 12 may be connected to servers corresponding to other types of transportation or recreation providers. Additionally, additional baggage information can be provided by baggage management server 12 and not a separate computer. Baggage management server 12 can provide destination information such as a hotel or an address where the destination is a place other than a destination airport instead of a second transportation mode.

A variety of information can be provided by cruise boat server 18 including a name or other identifier for a particular port where the cruise boat is docked. Baggage management server 12 can provide the cruise boat server with information sufficient to confirm a traveler's travel on the cruise boat. In an embodiment, baggage management server 12 and cruise boat server 18 operate on the same machine. Cruise boat server 18 may communicate a code or designation corresponding to a traveler's room location. For example, the code or designation may correspond to a floor or level of the traveler's room on the cruise boat as well as the room number. Accordingly, cruise boat employees or baggage delivery employees can identify where to deliver the baggage on the cruise boat from information communicated by cruise boat server 18 and subsequently generated on a baggage tag.

Baggage management server 12 is communicatively connected to at least one local operations server 20 that provides information about baggage pick up and other operational aspects of baggage management. In an example embodiment, a driver travels to the home of a traveler at a time and location provided to the driver by baggage management server 12. The time and location may be provided to baggage management server by the traveler via traveler interface 14. The driver can have in his or her possession (or located in the vehicle driven by the driver) a communication device with a delivery interface 22 through which messages are sent to and from baggage management server 12. At the home of a traveler or at another designated remote location, the driver tags each piece of baggage with a baggage tag having information communicated to the driver from baggage management server 12. Delivery interface 22 may also be configured to print or otherwise generate the baggage tag based on information received from baggage management server 12. In the situation where a traveler is traveling on both an airplane and a cruise boat during the same trip, baggage management server 12 may communicate information for a baggage tag with information sufficient for both the airplane and cruise transportation. In an alternative embodiment, baggage management server 12 may communicate only information sufficient for the airplane transportation.

Baggage statistics including time stamps for pick up, delivery at airport security, baggage fees owed, baggage category, etc. can be maintained by baggage management server 12 and stored in a database coupled to baggage management server 12. These baggage statistics may then be accessed as needed through baggage management server 12.

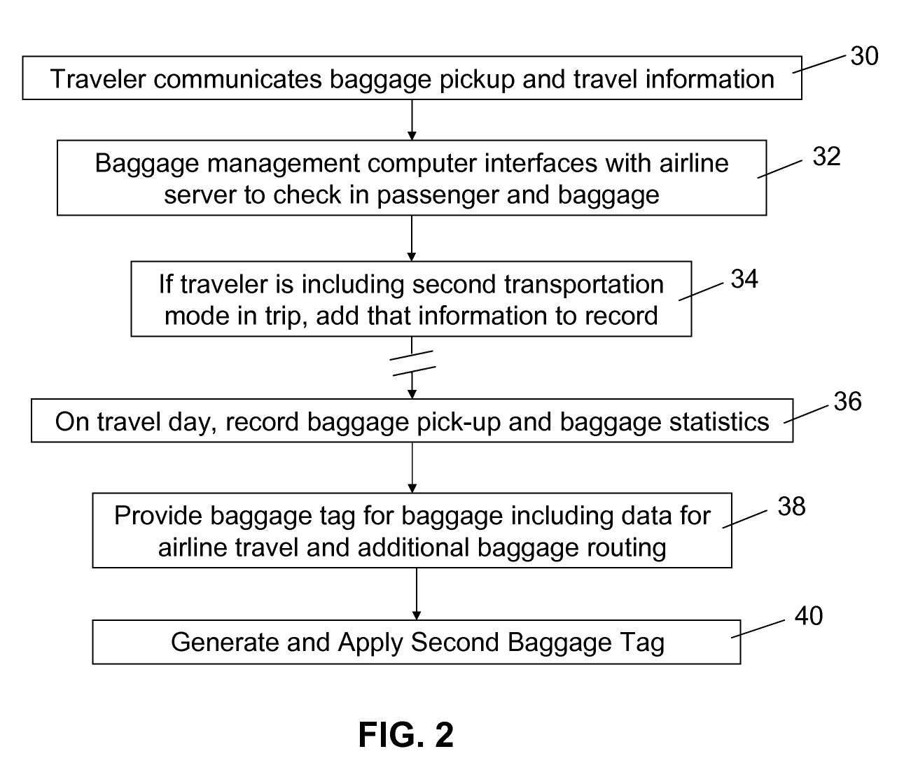

FIG. 2 is a flow diagram of representative operations performed in the system of FIG. 1. Additional, fewer, or different operations may be performed depending on the particular implementation. In an operation 30, a traveler communicates baggage pickup and travel information to a baggage management server. The traveler can provide such information using, for example, a traveler interface 14 provided at an Internet web site. Traveler interface 14 includes input fields which receive information on relevant dates, times, location, etc. of the flight and other scheduled transportation. Traveler interface 14 may also include input fields which receive personal information of the traveler, payment information, and baggage information. The information travel information received at traveler interface 14 is then communicated to baggage management server 12.

In an operation 32, a baggage management server interfaces with an airline computer or computer server to check-in the traveler and his or her baggage with the airline. Check-in procedures include providing identification of the traveler and serves to register or confirm a traveler's intent to travel on the particular flight. Depending on the particular airline, there may or may not be additional fees for checking luggage. Further, there may or may not be even more fees for baggage over a certain weight, such as fifty pounds. Such fees can be paid at check-in, when the bag is tagged, or via the traveler interface. In at least one embodiment, an indication is provided for the baggage tag to show whether a baggage fee has been paid already or is owed.

In an operation 34, if the travel itinerary of the traveler includes a second mode of transportation, such as a cruise boat or a train, information on the second mode of transportation is added to the record of the travel itinerary at the baggage management server. This information may include identification information for the transportation, departure and arrival dates and times, seat or room information, confirmation numbers, etc. The information also may or may not be associated with a common carrier, and may include destination information such as a hotel, business or residential address.

In an alternative embodiment, the information on the second mode of transportation is communicated from the baggage management server to the airline computer or server in operation 32 or in a subsequent operation. The traveler's record in the airline computer or server is then updated to include this information on the second mode of transportation or lodging. The traveler's record may also be updated to include a request for airline or airport personnel to generate and attach an additional routing baggage tag on the baggage that includes the information on the second mode of transportation or lodging.

On the travel day, a baggage management employee receives the baggage from the traveler at a remote location such as the traveler's home. In an operation 36, the baggage management server receives a message that the traveler's baggage has been picked up for delivery to the airport. The message that the baggage was picked up can be communicated from a remote device that receives input from the employee that travels to and picks up the baggage. The message may also include baggage statistics such as time stamps for pick up and delivery at airport security, baggage fees owed, baggage category, etc.

In an operation 38, baggage tag information is provided for the baggage from the baggage management server upon pick up at a designated location. The baggage tag information includes data for airline travel and additional baggage routing data. The additional baggage routing data may include data for additional modes of travel or lodging if required. The additional baggage routing data may be received from an entity, facility, or device located outside an airport or not affiliated with the airport or an airline. The baggage management employee that picks up the baggage may be required to verify identification of the person providing the baggage. An initial baggage tag can be printed at the remote location where the employee picks up the baggage, once baggage tag information is received and, if necessary, traveler identification is provided. In an alternative embodiment, the additional baggage routing data is not included on the initial baggage tag, and, is instead included on an additional routing baggage tag that is generated and applied to the baggage at a subsequent location, such as the airport.

The baggage is taken to a facility for security screening. The security screening facility may or may not be at or near an airport. After security screening, the baggage is transported to the airport. In an operation 40, a second baggage tag is generated at the airport based on the information included in the traveler's record stored on the airline computer or server. The additional routing baggage tag may include the additional baggage routing data and the associated information on the second mode of transportation or lodging. The additional routing baggage tag is applied to the baggage at the airport. The baggage is then eventually transported to a prescribed destination or to the second mode of transportation based on at least one of the initial and the additional routing baggage tags. Accordingly, the traveler is relieved of the baggage at his or her home or other designated location and will receive the baggage at the traveler's destination, for example, the traveler's room on the cruise ship. The traveler does not have to deal with the hassle of baggage check-in at the airport or the physical transportation of the baggage from place to place.

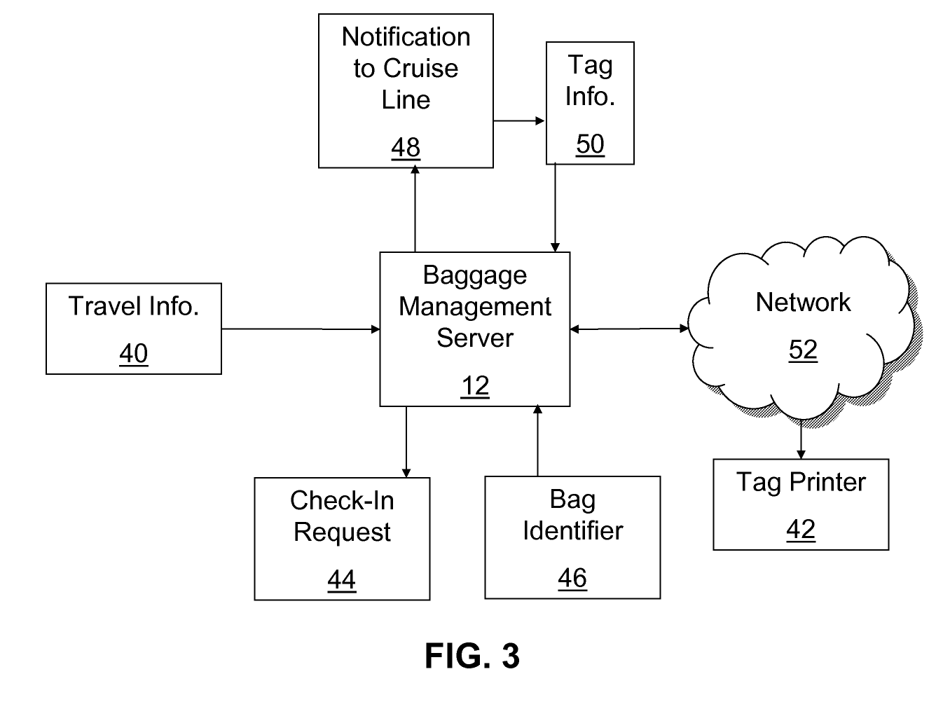

FIG. 3 illustrates communications to and from baggage management server 12 in the process of creating one or more baggage tags having airline and/or cruise line information contained thereon. Note that cruise line information may be substituted with any other mode of transportation, recreation, or lodging. Baggage management server 12 receives travel information 40 and, based on that information, communicates a check-in request 44 to an airline computer. The check-in request enables the traveler and the traveler's baggage to be remotely checked-in prior to travel. In this way the traveler may avoid the hassle of checking in on the travel day. In one representative embodiment, baggage management server 12 communicates information that enables a traveler to print an airline boarding pass at a self-serve kiosk or at a personal computer with a printer. In an alternative embodiment, travel information 40 may include information on a second mode of transportation or lodging. This information may include data required for further transportation of the baggage after its air travel. This information is included in the traveler's record on the airline computer or server. The traveler's record may later prompt airline, airport, or other personnel to apply an additional routing baggage tag to the baggage containing this information on a second mode of transportation or lodging.

Baggage management server 12 receives bag identification information 46 from the airline computer including, for example, an airline name, airline flight number, and a ten-digit IATA tag number. The bag identification information from the airline computer may be in the form of an airline bag tag identifier. Baggage management server 12 notifies a cruise line computer 48 that the traveler is checking-in for the airline reservation and, depending on the particular cruise line, may also check-in for the cruise. Cruise line computer 48 sends additional baggage routing information or data 50 that the cruise line wants included on the baggage tag to facilitate the baggage delivery to the cruise and, in particular, to the traveler's room. The information sent from the cruise line may be in the form of a cruise bag tag identifier. The information sent from the cruise line may be included in the information on the second mode of transportation or lodging that is sent from baggage management server 12 to the airline computer or server.

Baggage management server 12 communicates baggage tag information over a network 52 to a tag printer 42 which can be located at a dispatch location or in a vehicle that travels to the baggage location for baggage pick up. An initial baggage tag may be generated and attached to the baggage at pick up. As such, the initial baggage tag will include information required to appropriately route the baggage to the airport, to the cruise, and to the traveler's specific room. In an alternative embodiment, the initial baggage tag only includes information required to appropriately route the baggage to the airport and identify either the traveler or the traveler's flight. An additional routing baggage tag is generated and attached to the baggage at the airport based on information included in the traveler's record on the airline computer or server. In the alternative embodiment, the additional routing baggage tag includes the information required to transport the baggage from its flight to the cruise, and to the traveler's specific room.

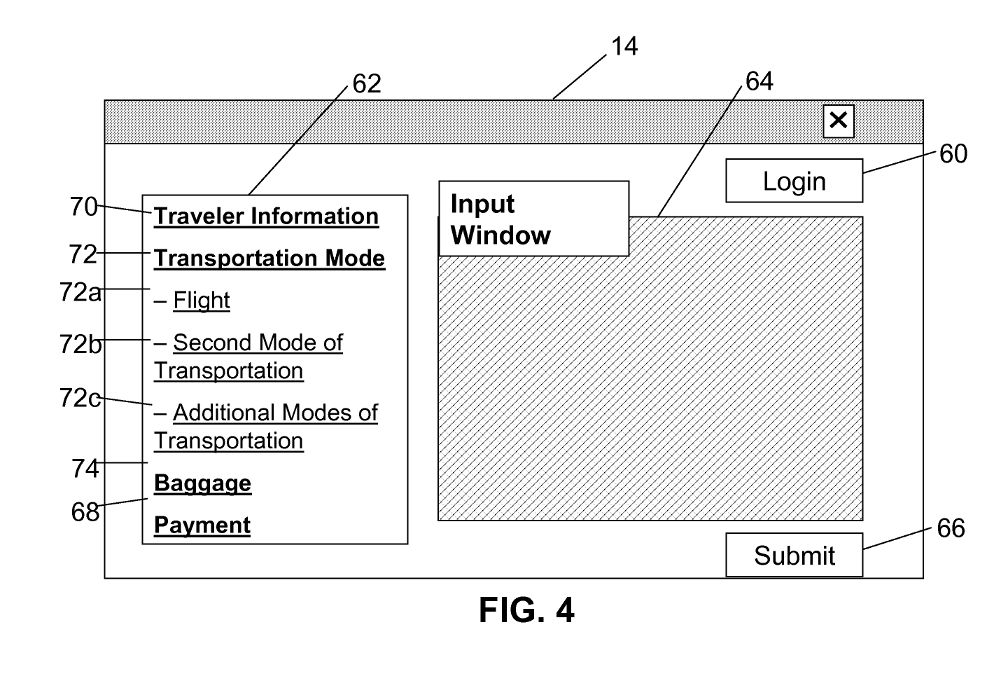

FIG. 4 illustrates a traveler interface 14 according to an embodiment. Additional or fewer elements may be included in traveler interface 14. Traveler interface 14 can include an Internet web page running on a personal computer (PC) or a personal data assistant (PDA), an interface on a communication device such as a telephone, an electronic data input device, or any other system capable of receiving information from a traveler. Traveler interface 14 receives travel information from the traveler and communicates it to a baggage management server. Traveler interface 14 may include a first window 62. First window 62 includes several hyperlinks configured to cause input window 64 to present various input fields corresponding to travel information. Upon receiving a selection of a hyperlink in first window 62, input window 64 may present data fields, drop down menus, or other input fields for receiving information from the traveler. Note that input window 64 may provide input fields for additional or less information pursuant to alternative embodiments. Upon receiving a selection of traveler information hyperlink 70 in first window 62, input window 64 may present input fields for receiving or updating personal information from the traveler.

First window 62 may also present a transportation mode header 72. Under transportation mode header 72, traveler interface 14 may receive a selection of flight information hyperlink 72a, a selection of a second mode of transportation hyperlink 72b, or a selection of an additional mode of transportation hyperlink 72c. Upon receiving a selection of a hyperlink corresponding to a transportation mode at first window 62, input window 64 may present input fields for receiving travel information associated with the mode of transportation hyperlink selected. For example, if flight information hyperlink 72a is selected, input window 64 may present input fields for receiving information such as a flight number, destination and arrival times, departure and arrival airports, etc. The input fields presented in input window 64 may vary depending on the mode of transportation for which information is being inputted.

Upon receiving a selection of baggage hyperlink 74, input window 64 may present input fields for receiving information as to the size, number, type, fragility, etc. of baggage that a traveler will be bringing with them. In addition, input window 64 may provide an input field for receiving information as to a designated time and place where the baggage is to be picked up by a baggage management employee. First window 62 may also provide a payment hyperlink 68 for inputting payment information. Upon receiving a selection of payment hyperlink 68, input window 64 may present input fields for receiving payment information from the traveler for services rendered with respect to baggage transportation or other services performed during the traveler's trip.

Traveler interface 14 may also provide a login hyperlink 60. Selection of login hyperlink 60 causes a login window to be presented, whereby a traveler may create an account with a password and username. In this way, the traveler may securely access and submit travel information. In addition, the traveler may input personal, payment, or other information which will be saved to the traveler's account and may be utilized in future trips.

After all of a traveler's personal, travel, baggage, and any other information has been inputted into traveler interface 14, the information may be submitted to a baggage management server by selection of submit input 66. In alternative embodiments, the information may be automatically submitted or saved to the baggage management server. Information inputted via traveler interface 14 may be stored at a database coupled to the baggage management server.

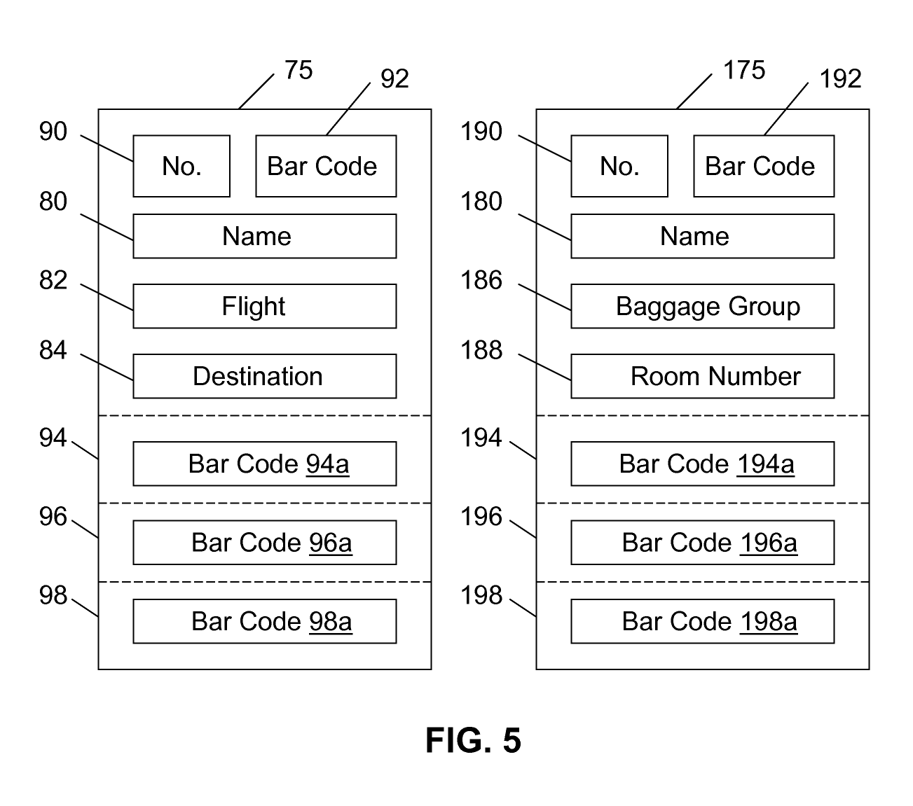

FIG. 5 illustrates an example an initial baggage tag 75 and an example additional routing baggage tag 175 as referenced throughout the specification. In an embodiment, baggage tag 75 includes air transportation information which is utilized to seamlessly transport baggage from a designated remote location, e.g., the traveler's home, to a first mode of transportation, e.g., the airport and the appropriate flight. Baggage tag 75 includes traveler identification information such as a name 80 to identify the traveler to which the baggage belongs. Baggage tag 75 also includes various flight information utilized to direct the baggage to the appropriate flight. Baggage tag 75 includes a flight number 82 which may also include a departure or arrival time. A destination airport code 84 may also be included on baggage tag 75. Baggage tag 75 also includes a unique baggage identification number 90 and a scannable bar code 92 to easily and uniquely identify the baggage.

Baggage tag 175 includes non-airline information on it, such as cruise information, destination information, fee payment status, etc. Baggage tag 175 includes cruise information which is utilized to seamlessly transport baggage from its flight to a traveler's end destination, e.g., the traveler's cruise ship room. Baggage tag 175 includes traveler identification information such as a name 180 to identify the traveler to which the baggage belongs. Baggage tag 175 also includes information associated with the traveler's cruise ship or other destination. Baggage group 186 indicates a baggage group with which the tagged baggage should be unloaded and routed. Room number 188 identifies the traveler's specific room on the cruise ship to which the baggage will be routed. The room number 188 may be used by cruise personnel or baggage management employees to route the baggage to the traveler's room after the baggage has arrived on the cruise ship. Baggage tag 175 also includes a unique baggage identification number 190 and a scannable bar code 192 to easily and uniquely identify the baggage.

As such, it is possible for baggage handlers to identify how and where baggage should be transported. In one representative embodiment, baggage tag 175 is generated by an airline computer which receives additional non-airline information. In another representative embodiment, baggage tag 75 is generated by a non-airline computer but it still has airline-compliant information contained thereon.

In addition, both baggage tags 75 and 175 may include several detachable tags 94, 96, 98. These detachable tags may include scannable bar codes 94a, 96a, 98a. The detachable tags may be attached to the outside of storage containers used to store the baggage during transportation. The detachable tags may be used to easily identify and track the baggage without having to locate individual baggage within a storage container. The storage containers may be secured or locked and, as such, may be difficult to access.

The computers referenced throughout the specification may include any type of computer or server known to those of skill in the art. These computers and servers may include a processor, a memory, a display, communication ports, and any other components known to those of skill in the art.

The foregoing description has been presented for purposes of illustration and of description. It is not intended to be exhaustive or limiting with respect to the precise form disclosed, and modifications and variations are possible in light of the above teachings or may be acquired from practice of the disclosed embodiments.

What is claimed is:

1. A method comprising:
receiving first travel information via a user interface, wherein the first travel information includes air travel information;
receiving, from a second transportation mode computer, additional baggage routing data for one or more bags of the traveler, wherein the additional baggage routing data comprises second travel information for subsequent lodging or for a second mode of transportation other than air travel;
communicating a check-in request to the airline computer to register a traveler and the one or more bags of the traveler with an airline; and
communicating the additional baggage routing data to the airline computer, wherein a record of the traveler on the airline computer is updated with the additional routing baggage data, and wherein the additional routing baggage data is included on an additional routing baggage tag applied to the one or more bags of the traveler at an airport or other facility associated with the airline.

2. The method of claim 1 further comprising:
receiving from the airline computer an airline bag tag identifier for each of the one or more bags of the traveler, wherein the airline bag tag identifier includes at least a portion of the first travel information; and
generating an initial bag tag for each of the one or more bags of the traveler at a location other than the airport, wherein the initial bag tag includes the airline bag tag identifier.

3. The method of claim 2, further comprising communicating the initial bag tag to a delivery interface.

4. The method of claim 1, wherein the second transportation mode is a cruise ship, and wherein the second transportation mode computer is a cruise line computer.

5. The method of claim 1, wherein the additional baggage routing data is included in a cruise bag tag identifier received from a cruise line computer.

6. The method of claim 1, further comprising communicating a registration request to the second transportation mode computer, wherein the registration request includes at least a number of the one or more bags of the traveler, and wherein the second transportation mode computer communicates the additional baggage routing data in response to the registration request.

7. The method of claim 1, wherein the second transportation mode computer is located outside the airport.

8. The method of claim 1, wherein the airline bag tag identifier includes an IATA (International Air Transport Association) number.

9. The method of claim 1, further comprising receiving information from the traveler designating a bag pick up time and location, wherein the location is a location other than an airport.

10. The method of claim 1, wherein the additional routing baggage tag is printed and applied to the one or more bags by personnel associated with the airline.

11. The method of claim 1, further comprising generating an airline boarding pass based on the air travel information and on information received from the airline computer.

12. The method of claim 1, wherein at least one of the additional routing or initial bag tags comprises at least one detachable portion for affixing to a storage container for efficient identification of the associated bag within the storage container.

13. The method of claim 1, further comprising receiving a message confirming pick up of the one or more bags of the traveler.

14. A system comprising:
a baggage management computer configured to:
receive first travel information via a user interface, wherein the first travel information includes air travel information;
receive an airline bag tag identifier from an airline computer;
receive additional baggage routing data from a second transportation mode computer for one or more bags of a traveler;
communicate a check-in request to the airline computer to register a traveler and the one or more bags of the traveler with an airline; and
communicate the additional baggage routing data to the airline computer, wherein a record of the traveler on the airline computer is updated with the additional routing baggage data, and wherein the additional routing baggage data is included on an additional routing baggage tag applied to the one or more bags of the traveler at an airport or other facility associated with the airline; and
a printing device configured to receive the airline bag tag identifier from the baggage management computer and generate an initial bag tag, wherein the initial bag tag includes the airline bag tag identifier.

15. The system of claim 14, wherein the printing device is further configured to receive the airline bag tag identifier via a wireless communication.

16. The system of claim 14, wherein the baggage management computer is further configured to communicate a registration request to the second transportation mode computer, and wherein the registration request includes information corresponding to the one or more bags of the traveler.

17. The system of claim 16, wherein the second transportation mode computer is configured to communicate the additional baggage routing data in response to the registration request.

18. The system of claim 14, wherein the printing device is further configured to send a message confirming pick up of the one or more bags of the traveler.

19. The system of claim 14, wherein the second mode of transportation is a cruise ship.

20. The system of claim 14, wherein the baggage management computer is further configured to generate an airline boarding pass based on the air travel information and on information received from the airline computer.
